(19) United States
(12) Patent Application Publication
(10) Pub. No.: US 2009/0095935 A1
(43) Pub. Date: Apr. 16, 2009

(54) Irrigation valve

(76) Inventor: Anthony M. Wlodarczyk, Yucaipa, CA (US)

Correspondence Address: ANTHONY M. WLODARCZYK, 13473 CANYON VIEW DR, YUCAIPA, CA, 92399, US

(21) Appl. No.: 11/973,618

(22) Filed: Oct. 10, 2007

(51) Int. Cl. F16K 7/12

(52) U.S. Cl. 251/331

(57) ABSTRACT

The present invention relates to a diaphragm valve, comprising: a valve body with an internal cavity and an inlet passage forming a continuous path of constant cross-section and minimal direction changes, allowing for less turbulent flow within the valve. The invention further comprises a valve cap mounted to a top of the valve body to cover the internal cavity, the valve cap comprising a solenoid port and a plurality of supporting ribs forming a continuous, channeled path allowing for reliable communication between the metering pin, the top of the diaphragm, and the solenoid port.

### FIELD OF THE INVENTION

The present invention generally relates to diaphragm valves, and more particularly, the present invention relates to an irrigation diaphragm valve that is clean, compact, reliable, and easy and inexpensive to manufacture and service, having a totally flat, stamped, fabric reinforced diaphragm, a body with integral diaphragm support that serves the dual role of stiffening and strengthening the body, an internal flow path that has minimal restrictions and direction changes to give low friction loss, and an actuation geometry that acts to minimize diaphragm travel and thus wear while not degrading the flow performance of the valve.

### BACKGROUND OF THE INVENTION

Landscape and agriculture irrigation valves are generally required to be of high value. To meet the markets' needs they need to be reliable and reasonably priced. As a result, most are solenoid controlled pilot actuated diaphragm valves. To keep the cost low, bodies, cap, and other components are generally molded using various types of plastic. While such valves have been manufactured for many years, their basic design has changed little.

Solenoid-operated isolation valves provide a fast, reliable response to meet continuous duty performance at low power levels. Performance and applicability is related to optimum body material, seal, flow path, flow rates and pressure to provide the best value and highest level of compatibility with a wide range of fluids, chemicals and fluid conditions.

Most conventional diaphragm valves utilize a diaphragm with one or two flat planes. In some embodiments of the reference diaphragm valves, the flat diaphragm has a convolution or a central recess region that is relatively flat. The first flat plane at periphery of the diaphragm is usually at a different elevation than the second flat plane at central recess of the diaphragm. A two-plane diaphragm usually supports a smaller fluid inlet area than that of a totally flat diaphragm plane

U.S. Pat. No. 6,854,713 issued on Feb. 15, 2005, entire contents of which are incorporated herein by reference, discloses a diaphragm valve with a metal dish-type diaphragm and a non-metal valve base configured to reduce the friction of diaphragm movement and lower the leakage rate of the valve.

U.S. Pat. No. 6,845,960 issued on Jan. 25, 2005, entire contents of which are incorporated herein by reference, discloses a diaphragm valve with a guide conduit, whereby the diaphragm opens the guide conduit when fluid received in a space between a cap and a diaphragm of the valve having a high pressure is discharged into an outlet-side space. When fluid is discharged from the pipe-shaped button, the diaphragm is moved toward the guide conduit, and the valve stem closes the outlet.

U.S. Pat. No. 6,789,542 issued on Sep. 14, 2004, entire contents of which are incorporated herein by reference, discloses a valved tracheotomy tube device with low-profile valve housing covered with an attractive decorative cap.

U.S. Pat. No. 6,786,471 issued on Sep. 7, 2004, entire contents of which are incorporated herein by reference, discloses a diaphragm valve assembly comprising a body defining a valve chamber and a removable annular valve seat installed in the valve chamber, and a flexibly resilient diaphragm.

U.S. Pat. No. 6,786,470 issued on Sep. 7, 2004, entire contents of which are incorporated herein by reference, discloses a diaphragm valve which allows for free-draining of a valve body of the valve when the valve is in the open position. A bottom line extending through the inlet passage of the valve, the internal cavity and the outlet passage forms a coplanar surface to allow for free-drainage of the body.

U.S. Pat. No. 6,715,737 issued on Apr. 6, 2004, entire contents of which are incorporated herein by reference, discloses a fuel metering system for a combustion engine carburetor utilizing a non-convoluted, planar, flexible diaphragm which does not require a molding process to form a traditional convolution.

U.S. Pat. No. 6,352,144 issued on Mar. 5, 2002, entire contents of which are incorporated herein by reference, discloses a flow control valve including a resilient diaphragm, which is acted upon by pressure in the flow path and which is moveable towards and away from the free end of a hollow boss. A bypass passage defining a pressure relief valve is disposed downstream of the flow restrictor and permits flow between the inlet and outlet ports when the flow control valve is closed.

U.S. Pat. No. 6,196,521 issued on Mar. 6, 2001, entire contents of which are incorporated herein by reference, discloses a valve for directing pressurized fluid in a substantially planar manner with a flexible diaphragm actuated manually or programmed to dispense pressurized or anaerobic reactive fluid.

U.S. Pat. No. 5,964,446 issued on Oct. 12, 1999, entire contents of which are incorporated herein by reference, discloses a fluid control valve having a flexible elastomeric diaphragm with a formed convolution. An elastomeric diaphragm regulator with a valve actuator is coupled to a guided valve stem attached to the regulator diaphragm.

U.S. Pat. No. 5,213,303 issued on May 25, 1993, entire contents of which are incorporated herein by reference, discloses an improved solenoid actuated valve having a fluid pressure-operated diaphragm to move a valve head between open and closed positions, wherein the position of a flow control piston within the control chamber is adjustable to variably select the open position of the valve head in accordance with a desired valve flow rate.

U.S. Pat. No. 4,653,526 issued on Mar. 31, 1987, entire contents of which are incorporated herein by reference, discloses a diaphragm valve for removal of samples from a pipeline for water of predetermined microbiological purity and means for sealing the inlet by the central portion of a substantially flat diaphragm.

U.S. Pat. No. 4,505,450 issued on Mar. 19, 1985, entire contents of which are incorporated herein by reference, discloses a solenoid-operated pilot-actuated valve including a diaphragm chamber into which fluid is introduced to establish a fluid pressure which normally forces the diaphragm against an annular seat in the valve to maintain the valve in a closed condition. Movement of the diaphragm causes a guide mounted on the diaphragm to move up and down with respect to the bleed tube to provide a self-cleaning action in the annular passage.

U.S. Pat. No. 4,353,243 issued on Oct. 12, 1982, entire contents of which are incorporated herein by reference, discloses a multiport diaphragm valve with no moving parts other than the control diaphragm, operability over a wide range of operating conditions.

U.S. Pat. No. 4,304,260 issued on Dec. 8, 1981, entire contents of which are incorporated herein by reference, discloses a flexible diaphragm valve device for a metering unit with a planar sheet flexible diaphragm adapted to be formed in the area over the valve seat by placing the valve cover on the valve body with the flexible diaphragm therebetween.

U.S. Pat. No. 4,176,686 issued on Dec. 4, 1979, entire contents of which are incorporated herein by reference, discloses a flow control valve with the valve seat formed as an integral part of a plastic valve housing, on a thin inwardly protruding plate to limit cavitation and improve sealing characteristics of the valve.

U.S. Pat. No. 3,967,808 issued on Jul. 6, 1976, entire contents of which are incorporated herein by reference, discloses a pilot-operated diaphragm-type irrigation valve having a plastic body defining a flow passage therethrough, the valve including a diaphragm actuable to move a seal toward and away from an internal surface of the body around the flow passage to close and open the valve. The improved valve seat comprises a metal seat ring having a generally U-shaped cross-section formed by a seat portion and a pair of spaced-apart sidewalls integrally formed with and extending from the seat portion, the sidewalls being oblique to a central axis of the ring.

U.S. Pat. No. 3,655,163 issued on Apr. 11, 1972, entire contents of which are incorporated herein by reference, discloses a diaphragm valve with a diaphragm including an inner portion and a flexible peripheral edge defining a space therebetween, the space being subjected to outlet pressure and an outer surface being subjected to inlet pressure whereby the peripheral edge flexes inward in response to increased inlet to outlet pressure differentials.

U.S. Pat. No. 3,495,804 issued on Feb. 17, 1970, entire contents of which are incorporated herein by reference, discloses a diaphragm-type valve in which the throttle is designed as an annular passage between the wall of a bore and the outer circumferential surface of a cylindrical push rod connected to the diaphragm and extending axially into the bore.

U.S. Pat. No. 3,240,128 issued on Mar. 15, 1966, entire contents of which are incorporated herein by reference, discloses a diaphragm valve with a diaphragm having a peripheral portion with knife-like edges, wherein the peripheral portion is permitted to slide inwardly and outwardly in a generally radial direction past the knife-like edges as the diaphragm is flexed.

U.S. Pat. No. 3,083,943 issued on Apr. 2, 1963, entire contents of which are incorporated herein by reference, discloses a casing of a diaphragm valve having a pair of separable sections presenting a chamber therewithin having inner surfaces of arcuate configuration throughout.

U.S. Pat. No. 3,078,066 issued on Feb. 19, 1963, entire contents of which are incorporated herein by reference, discloses a pressure operated diaphragm valve including a tapered vaned diaphragm-supporting element located substantially centrally on the diaphragm and a column attached to the supporting element that is slidable within the first compartment of the valve.

U.S. Pat. No. 3,022,039 issued on Feb. 20, 1962, entire contents of which are incorporated herein by reference, discloses a diaphragm for a valve comprising a rim for securing the diaphragm within the valve body, an intermediate valve seat-contacting portion to regulate the opening and closing of the valve, and a circumferential ridge including spaced recessed portions extending substantially the full depth of the ridge.

U.S. Pat. No. 2,989,282 issued on Jun. 20, 1961, entire contents of which are incorporated herein by reference, discloses an irrigation valve with an imperforate flexible circular diaphragm of uniform thickness abutting a flange and moving into and away from abutment.

U.S. Pat. No. 2,838,269 issued on Jun. 10, 1958, entire contents of which are incorporated herein by reference, discloses a diaphragm valve with a self purging bleed port, effecting a scrubbing action to maintain the bleed port open.

U.S. Pat. No. 2,572,175 issued on Oct. 23, 1951, entire contents of which are incorporated herein by reference, discloses a solenoid-actuated valve operator with a fluid impervious diaphragm and electromagnetically-energized operator having utility as a control device.

U.S. Pat. No. 2,537,308 issued on Jan. 9, 1951, entire contents of which are incorporated herein by reference, discloses a diaphragm valve with a diaphragm made of resiliently deflectable material and an outer marginal flange gasket portion including a plurality of side edges each of which is formed concave to allow for the radial displacement of the gasket.

None of the prior art discloses a diaphragm valve with an inlet port and an outlet port configured parallel side by side that are oriented coming out of the bottom of the valve. Furthermore, none of the prior art discloses that the seat against which the diaphragm assembly seals has a large diameter compared to the nominal pipe size of the valve with a ratio of 1.5 to 1 or more. Still furthermore, none of the prior art discloses using internal ribbing structures in the body and/or cap enabling a continuous, channeled pathway to allow for secure communication of fluid.

In accordance with the present invention there is provided a low-cost diaphragm valve that is designed and configured for trouble-free use in applications requiring minimal maintenance, maximum lifetime, and easy cleaning, such as in irrigation industry, in food industry, in brewery industry or in medical industry. Furthermore, there is provided a diaphragm valve having a flexible diaphragm that does not require a molding process to form traditional convolution. In particular, the diaphragm valve of the invention requires a minimum diaphragm travel to open the valve; thus minimizes wear and maximizes smooth closing reliability.

### SUMMARY OF THE INVENTION

In general, it is an object of the present invention to provide a diaphragm valve with a totally flat diaphragm and a flow path through the valve that minimizes direction and cross sectional area changes as much as possible. As it turns out, these ends are compatible with keeping the volume of the enclosure formed by the valve to minimum, which in turn lends itself to minimizing the material required to construct the valve. At the same time, structural and supportive ribs are in the interior portions of the cap and body to keep the outward appearance of the valve as clean and stylish as possible.

Some aspects of the invention relate to a diaphragm valve, comprising: a) a valve body, the valve body comprising: an internal cavity formed in the body, wherein the internal cavity is substantially divided into an inlet portion and an outlet portion; an inlet passage formed in the body, the inlet passage having an inlet opening, the inlet opening being in fluid communication with the internal cavity; an outlet passage formed in the body, the outlet passage having an outlet opening, the outlet opening being in fluid communication with the internal cavity; b) a diaphragm assembly comprising a totally flat diaphragm with a spool shaped spacer/diaphragm support attached and sealed at a diameter much smaller than the spool flange OD that offsets the seal diameter in a manner that allows unrestricted flow through a seat of minimal diameter, around the seal, and past the spool shape with minimal diaphragm flexure inside a body of minimal diameter, the flat diaphragm having a circumferential sealing surface formed on a wall of the outlet portion of the internal cavity, the circumferential sealing surface being sealed between the inlet opening and the outlet opening and circumferentially around the internal cavity,; c) a valve cap having a cap cavity, the cap being mounted to a top of the valve body to cover the internal cavity; and d) a metering pin supported by the body configured for cooperating with a metering orifice in the diaphragm assembly to meter communication between the inlet passage and a solenoid port and to guide the travel of the diaphragm assembly.

In one embodiment, the metering pin is configured for cooperating with the metering orifice in the diaphragm assembly to provide a self cleaning metering restriction between inlet fluid and the cap cavity such that when the solenoid, or manual actuation, opens and closes a flow path to the outlet port, the cap cavity empties or fills causing the diaphragm to open and close communication between the inlet passage and the solenoid port.

In one embodiment, the diaphragm valve further comprises a solenoid port with a solenoid actuator for controlling an opening and closing action of the fluid flow. In another embodiment, the diaphragm valve further comprises a downstream manual bleed for bleeding the fluid from the cap cavity so as to open the valve. The preferred embodiment comprises both.

In some embodiments, the totally flat diaphragm is manufactured by a stamping process.

In one embodiment, the crown of the cap of the diaphragm valve is configured in a circular or an elliptical shape.

Some aspects of the invention provide the cap cavity of the valve cap with a plurality of cap ribs that provides support for the diaphragm, sized and configured for enabling a continuous, channeled flow of the fluid and enabling a fluid communication path between the metering pin and the solenoid port under any circumstance.

Some aspects of the present invention relate to a method of controlling flow of a fluid in a less turbulent manner, the method comprising: providing a diaphragm valve that comprises an internal cavity, an inlet passage, a fluid inlet pipe having a pipe diameter, an outlet passage, a diaphragm assembly comprising a totally flat diaphragm with a spool shaped spacer between the diaphragm and seat that, in conjunction with the body that has minimal changes in flow path direction and consistent cross section flow path areas, with minimal deflection results in forwarding the fluid toward the outlet passage; and directing the fluid to the downstream exit port.

### BRIEF DESCRIPTION OF THE DRAWINGS

Additional objects and features of the present invention will become more apparent and the invention itself will be best understood from the following Detailed Description of Exemplary Embodiments, when read with reference to the accompanying drawings.

FIG. 1 shows a perspective view of the valve body of a diaphragm valve according to the principles of the present invention.

FIG. 2 shows a totally flat diaphragm used in the present diaphragm valve.

FIG. 3 shows a front elevational view of the diaphragm subassembly.

FIG. 4 shows a perspective view of the valve cap of the diaphragm valve.

FIG. 5 shows a cross-sectional illustration of the exploded view for the diaphragm valve system.

FIG. 6 shows a perspective exploded view for the diaphragm valve system.

### DETAILED DESCRIPTION OF EXEMPLARY EMBODIMENTS

The following detailed description is of the best presently contemplated modes of carrying out the invention. This description is not to be taken in a limiting sense, but is made merely for the purposes of illustrating general principles of embodiments of the invention.

Diaphragm irrigation valves have been around for a long time. Flat diaphragms have been used in irrigation and other valves for a long time. Manual irrigation valves have had seals on disks at the end of a stem to accomplish much the same thing as the spool shaped spacer does in the current invention. There have been actuators that convert the manual valves into electrically actuated automatic valves that attach a diaphragm to the end of an elongated stem by means of a disk attached to the top of the stem, the disk being attached to the diaphragm near the outside diameter of the disk, which requires the outside diameter of the diaphragm to be quite large in order to have the required flexibility to give the stem the required travel. The current invention shortens the stem and attaches the diaphragm to the disk at a substantially smaller diameter than the outside diameter of the disk, which in turn allows the outside diameter of the diaphragm of the disk to be smaller as well while still maintaining sufficient flexibility. The current invention integrates all these features to optimize the function of the valve.

On further analysis as disclosed herein, it came to light that a spool shaped spacer would also mean that the diaphragm doesn't need to travel as far and that the resulting geometry lent itself to be an efficient flow path. Analyzing the diaphragm further, it became apparent that the flexibility would be substantially improved if it were affixed only at the center of the rigid center portion of the diaphragm assembly rather than at a diameter that is larger than the seat. The body of the valve is also shaped so as to minimize flow direction changes, while still maintaining a geometry that is easier to manufacture, can be manufactured from inexpensive commodity grade plastic resins, and results in a better performing valve.

Some aspects of the invention provide a flat diaphragm for simplicity and ease of manufacturing used in an irrigation diaphragm valve.

In one embodiment, beads on cap and valve body capture a diaphragm and create two permanent seals at a first location between the downstream bleed and the body, and a second location at between the diaphragm chamber and the valve cap. The cap ribs and the cap provide structural support to the pressure vessel, support for the diaphragm assembly, and communication channel to downstream bleed.

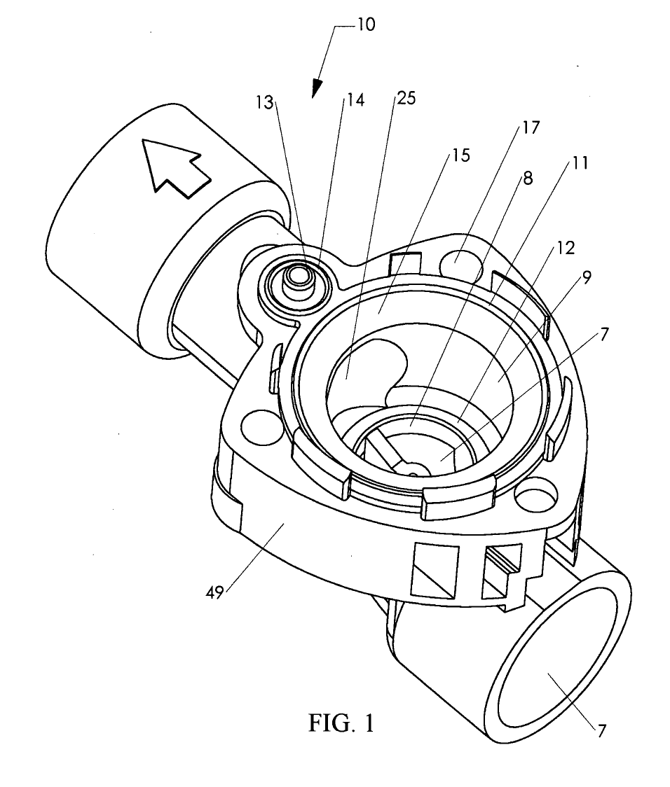

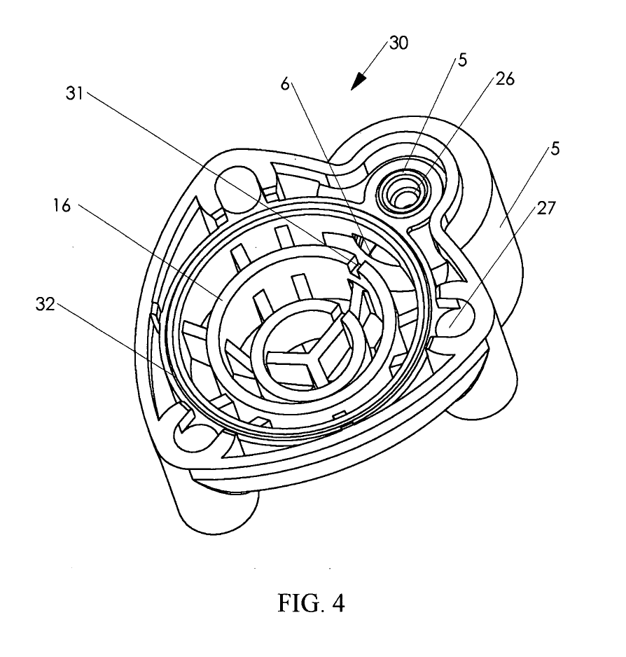

FIGS. 1 and 4 show a perspective view of the valve body 10 and valve cap 30 of a diaphragm valve according to the principles of the present invention. The valve body comprises an internal cavity 9 formed in the body 10, an inlet passage 8 formed in the body, wherein the inlet passage has an inlet opening or inlet port 7 that is in communication with the internal cavity 9. The body comprises a skirt 49 and a plurality of ribs (not clearly visible) external to the cavity, but hidden by the skirt 49, that support surface 15 that forms part of the support of the flat diaphragm 18 in the valve body when the diaphragm assembly 47 is in its closed position.

In one embodiment, the valve body 10 is provided with a plurality of spaced-apart peripheral holes 17, co-extensive from the main body for receiving a nut-and-screw securing system that securely tightens the valve cap 30 via corresponding matching holes 27 onto the valve body 10, incorporating a flat diaphragm 18 properly placed in between. A lower downstream communication shaft 13 of the valve body is provided at adjacent to a peripheral section 25 of the valve body 10, wherein a downstream bite 14 is provided at about the downstream communication shaft for properly seating the valve cap.

The valve cap 30 of the valve structure comprises a pilot outlet passage 6 formed, wherein the pilot outlet passage leads to the solenoid port 48, the outlet opening being in communication with the internal cavity 9 through the metering pin region of the diaphragm. The valve cap provides cap bites 32 and 5 to act in conjunction with the bites 11 and 14 of the body 10 for properly seating the diaphragm 18 so as to seal the main valve cavity and the communication path between the solenoid port 48 and the outlet port 50. Some aspects of the invention provide an arrangement of cap flow grooves 31 such that the internal cavity of the valve structure forms a continuous, clear path to allow for secure communication of pilot fluid to the solenoid port 48.

The valve cap 30 may comprise a plurality of cap ribs (ribbing structures) or risers 31 properly sized, shaped and oriented to support the flat diaphragm 18 as placed in the valve body. In one embodiment, at least a portion of the ribs are secured to the roof of the valve cap in a configuration essentially perpendicular to the floor plane. After securing the cap onto the valve body, the upper downstream communication shaft 26 of the valve cap matches in-line with the lower downstream communication shaft 13 for disposing the fluid from the top of the diaphragm. In one embodiment, the inlet section and the outlet section of the diaphragm valve are made with PVC (polyvinyl chloride) body with slip port or quick connections. In another embodiment, the inlet port and the outlet port are threaded or barbed.

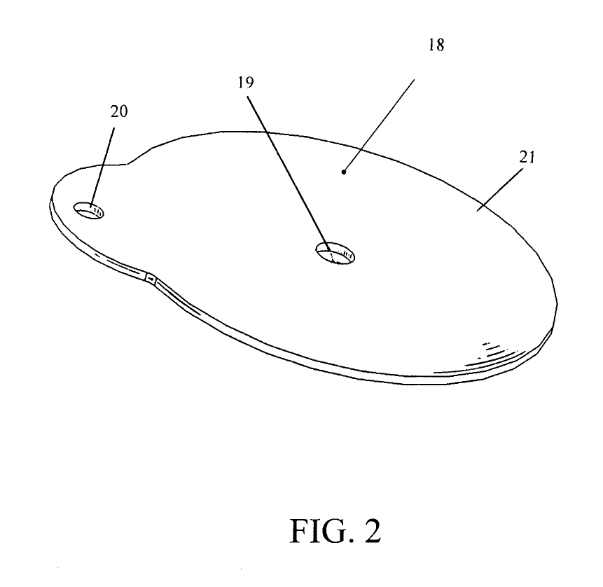

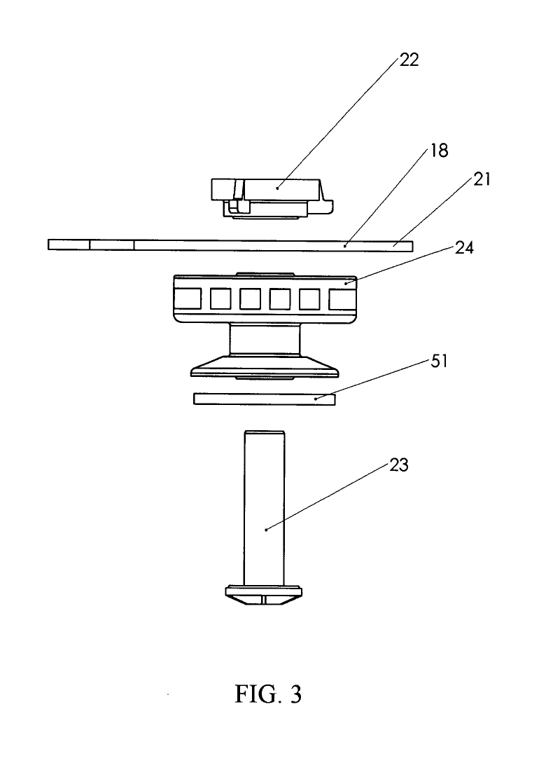

FIG. 2 shows a totally flat diaphragm with a periphery 21 that is used in the present diaphragm valve, whereas FIG. 3 shows a front elevational view of the diaphragm subassembly. The diaphragm comprises a central opening 19 for receiving the metering pin 46 for the purposes of flow metering and a side opening 20 for orienting and stabilizing the diaphragm onto the valve body 10 and providing a path and seal for the downstream bleed path for the solenoid operated, and manually operated, pilot actuation of the diaphragm. The diaphragm may be made of a material selected from a group consisting of chlorine and chloramines resistant thermal set elastomers, with or without fabric reinforcement. The diaphragm seat has a seat diameter, wherein the diaphragm seat 12 is defined in FIG. 1.

FIG. 3 shows a front elevational view of the diaphragm subassembly 47, wherein the subassembly comprises a diaphragm 18 with a periphery 21, a diaphragm spacer 24 and rubber seal 51, a set of metering orifice 23 and retaining nut 22 to securely hold the diaphragm, spacer, and rubber seal. The periphery 21 is squeezed by sealing beads 11 and 32 while the immediately adjacent to 21 is usually supported by the supporting rib 16 or land 15 as provided. The one piece flat diaphragm of the invention can be made by a stamping process and the diaphragm assembly is very simple and rugged.

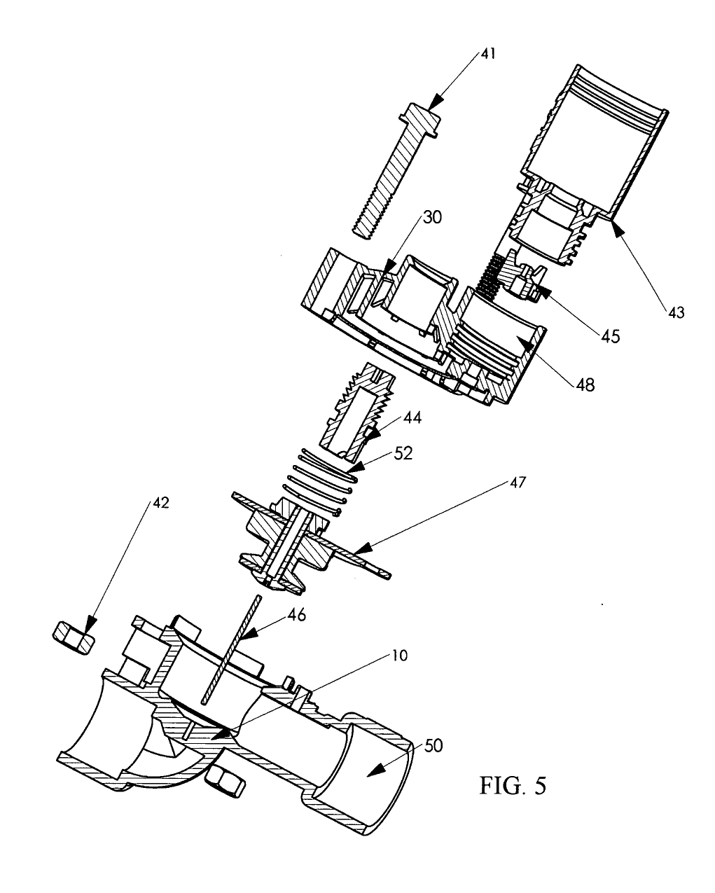

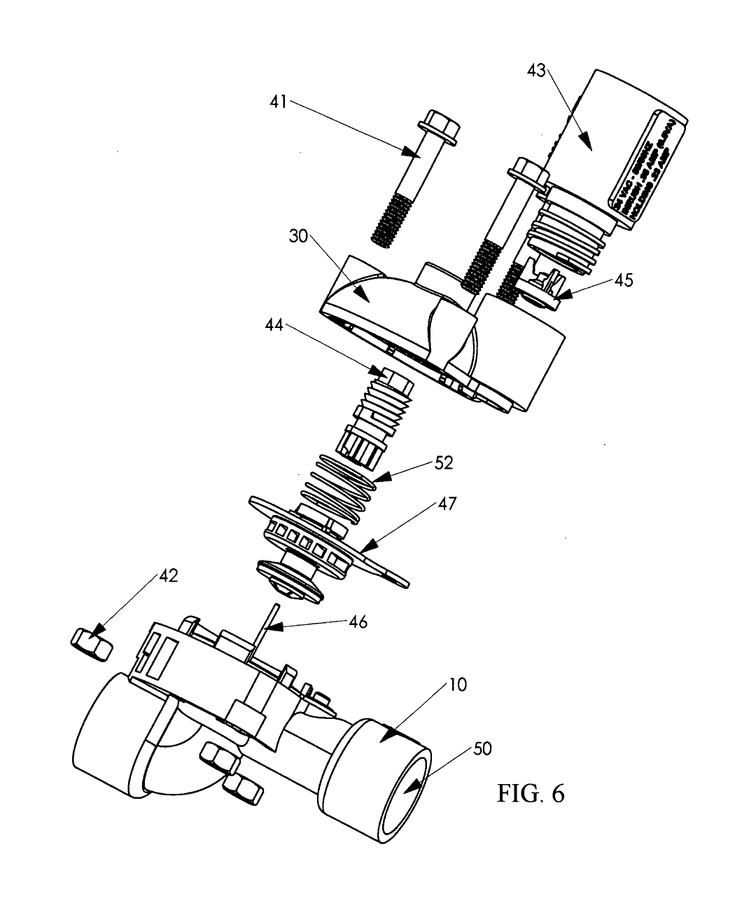

FIG. 5 shows a cross-sectional illustration of the exploded view for the diaphragm valve system, whereas FIG. 6 shows a perspective exploded view for the diaphragm valve system. A complete list identifying all components and parts for the diaphragm valve of the present invention is shown in FIG. 6 wherein a set of the auxiliary nuts 42 and their matching screws 41 are used to securely tightening the cap to the body. Spring 52 biases the diaphragm assembly towards the closed position. Optional flow control stem 44 adjustably limits how far the diaphragm assembly can open. Some aspects of the invention provide a diaphragm valve that is easy to assemble and disassemble for cleaning. In a further embodiment, the parts and components are designed and made low cost and reliable. The parts are designed in such a manner as to minimize distortion during a molding process of certain parts. The valve cap 30 and the body 10 are sized and configured with proper material to have low stress with minimum creep. Some aspects of the invention provide a rib structure 16 and land 15 to provide high stiffness and excellent support for the diaphragm in the open or closed position.

In one embodiment, the valve uses internal ribbing structures in the cap. This configuration does not appear to have previously been used in irrigation valves. There are numerous advantages to using this configuration.

The advantage of using internal ribbing structures is to improve the cap in the following ways:
1. They create clear passage ways for water to communicate from the top of the diaphragm to the solenoid port, necessary for the reliable functioning of the valve.
2. The strength of the pressure vessel is enhanced.
3. They can support the diaphragm when the valve is open.
4. Being inside the cap, they do not spoil the clean appearance of the valve.

In some embodiment, the cap of the diaphragm valve is configured with an elliptical shape with a smooth exterior surface that provides strength, shows good appearance and minimal dirt entrapment. Other appropriate shapes are within the scope of the present invention.

In one embodiment, the diaphragm valve of the invention comprises a solenoid port 48, a solenoid actuator 43 with a combination plunger retainer and filter 45 that facilitates manual downstream bleed, protection from debris intrusion, and containment of the plunger.

Some aspects of the invention relate to a diaphragm valve, comprising: (a) a valve body, the valve body comprising: an internal cavity formed in the body, wherein the internal cavity is substantially divided into an inlet portion and an outlet portion; an inlet passage formed in the body, the inlet passage having an inlet opening, the inlet opening being in communication with the internal cavity; an outlet passage formed in the body, the outlet passage having an outlet opening, the outlet opening being in communication with the internal cavity; (b) a diaphragm assembly comprising a totally flat diaphragm with a seat diameter, the flat diaphragm having a circumferential sealing surface formed on a wall of the outlet portion of the internal cavity, wherein the circumferential sealing surface is sealed between the inlet opening and the outlet opening and circumferentially around the internal cavity, wherein the internal cavity of the body forms a continuous path of constant cross sectional area and of minimal direction changes, allowing for less turbulent flow within the body; (c) a valve cap having a cap cavity, the cap being mounted to a top of the valve body to cover the internal cavity; and (d) a metering pin supported by the body configured for cooperating with the metering orifice in the diaphragm assembly to meter communication between the inlet passage and the solenoid port.

The diaphragm valve of the present invention further comprises a solenoid port with a solenoid actuator for controlling an opening and closing action of the fluid flow to the outlet passage, which activate diaphragm for opening or closing the valve. In one embodiment, the diaphragm valve of the invention further comprises a downstream manual bleed for bleeding fluid from the cap cavity so as to open the valve. While manual and solenoid actuation could be implemented separately, the instant valve implements both, giving the user two options, for use under different circumstances.

In one embodiment the cap cavity of the diaphragm valve comprises a plurality of cap ribs sized and configured for enabling a continuous, channeled flow of the fluid and enabling a fluid communication path between the metering pin and the solenoid port under any circumstance. The ribs in the cap provide a guaranteed flow path between the metering orifice/pin and the solenoid port.

In one embodiment, the diaphragm assembly serves several sealing functions, including 1) cap cavity to the atmosphere, 2) body cavity to the atmosphere, 3) downstream bleed passageway between the cap and body, 4) when closed, against the seat between the inlet portion and the out portion of the internal cavity of the body. Furthermore, the diaphragm isolates the cap cavity from the body cavity. A piloting amount of water communicates between the two cavities via the metering orifice in about the center of the diaphragm assembly and via the downstream bleed passageway when opened manually or with the solenoid.

The valve body possesses both inlet and outlet portions and the inlet cavity associated with them. In still another embodiment, the downstream bleed passage communicates between the cap cavity and the outlet port of the valve body via the solenoid port feature in the cap. In a further embodiment, the metering pin in conjunction with the metering orifice in the diaphragm assembly controls the rate of flow from the inlet portion of the body cavity to the cap cavity. When the solenoid is activated or the manual bleed feature is used, water flows out of the cavity faster than it flows in, causing the diaphragm assembly to rise and the valve to open. When the downstream bleed passage is closed, the cap cavity fills, forcing the diaphragm assembly down, which cuts off the flow of water between the inlet and outlet portions of the body cavity.

From the foregoing description, it should now be appreciated that a novel and unobvious diaphragm valve for controlling fluid flow has been disclosed for a variety of applications. While the invention has been described with reference to a specific embodiment, the description is illustrative of the invention and is not to be construed as limiting the invention. Various modifications and applications may occur to those who are skilled in the art, without departing from the true spirit and scope of the invention.

What is claimed is:

1. A diaphragm valve, comprising:
a) a valve body, said valve body comprising:
an internal cavity formed in said body, wherein the internal cavity is substantially divided into an inlet portion and an outlet portion;
an inlet passage formed in said body, said inlet passage having an inlet opening, said inlet opening being in fluid communication with said internal cavity;
an outlet passage formed in said body, said outlet passage having an outlet opening, said outlet opening being in fluid communication with said internal cavity;
b) a diaphragm assembly comprising a totally flat diaphragm attached to a piston-spool shaped spacer, said spacer having a seal at the end opposing the diaphragm to seal against the inlet to the internal cavity, while the OD of the diaphragm forms a seal between the cap and body, said spacer being clamped to the said diaphragm at a diameter considerably smaller than the O.D. of said spacer, said diaphragm resting against circular surface of the said spacer;

2. The diaphragm valve according to claim 1, wherein said solenoid port comprises a solenoid actuator for controlling an opening and closing action of the fluid flow.

3. The diaphragm valve according to claim 1, further comprising a downstream manual bleed for bleeding fluid from the cap cavity so as to open the valve.

4. The diaphragm valve according to claim 1, wherein the totally flat diaphragm is manufactured by a stamping process.

5. The diaphragm valve according to claim 1, wherein the cap is configured an elliptical shape.

6. A diaphragm valve comprising a diaphragm and a valve body with an internal cavity therein, wherein the internal cavity comprises an integral diaphragm support and is structurally stiffened and strengthened by external ribs and a sleeve.

7. The diaphragm valve according to claim 6, wherein the internal cavity is of the minimal size required to avoid restriction of flow through said internal cavity.

8. The diaphragm valve according to claim 6, wherein the cap forms a cavity above the diaphragm, said cap cavity comprises a plurality of cap ribs sized and configured for supporting the diaphragm when it is in the open position.

9. The diaphragm valve according to claim 8, wherein the cap ribs are sized and configured for enabling a fluid communication path between the metering pin and a solenoid port under any circumstance.

10. A method of controlling flow of a fluid in a less turbulent manner, the method comprising:
providing a diaphragm valve that comprises an internal cavity, an inlet passage, a fluid inlet pipe having a pipe diameter, an outlet passage, a diaphragm assembly comprising a totally flat diaphragm with an effective diaphragm diameter and a spacer with a seal opposing the said diaphragm, wherein said spacer is spool shaped;
allowing the fluid to pass from the inlet passage with minimal restriction;
forwarding the fluid toward the outlet passage; and
directing the fluid to the downstream exit port.

11. The method according to claim 10, wherein the valve further comprises a solenoid port with a solenoid actuator for controlling an opening and closing action of the fluid flow.

12. The method according to claim 10, wherein the valve further comprises a downstream manual bleed for bleeding the fluid from the cap cavity so as to open the valve.

13. The method according to claim 10, wherein the totally flat diaphragm is manufactured by a stamping process.

14. The method according to claim 10, wherein the valve further comprises a valve cap that is configured an elliptical shape.

15. A method of supporting the diaphragm of a diaphragm valve, the method comprising:
providing a body having an integral support for the diaphragm when it is in its closed position.

16. The method according to claim 15, wherein the internal cavity is of the minimal size required to avoid restriction of flow through said internal cavity.

17. The method according to claim 15, wherein the cap of the valve forms a cavity which contains a plurality of internal cavity ribs that provide support for the diaphragm, when the diaphragm is in its opened position.

18. The method according to claim 15, wherein the internal cavity ribs are sized and configured for enabling a continuous, channeled, unobstructed flow of the fluid from the metering pin to the solenoid port.
